(19) United States
(12) Patent Application Publication
(10) Pub. No.: US 2007/0258606 A1
(43) Pub. Date: Nov. 8, 2007

(54) Method and arrangement for recording and playing back sounds

(76) Inventor: Werner Dabringhaus, Detmold (DE)

Correspondence Address: WINSTEAD PC, P.O. BOX 50784, DALLAS, TX, 75201, US

(21) Appl. No.: 11/796,841

(22) Filed: Apr. 30, 2007

Related U.S. Application Data
(63) Continuation of application No. 10/168,642, filed on Aug. 29, 2002.

(30) Foreign Application Priority Data
Dec. 22, 1999 (DE) 199 61 862.3

(51) Int. Cl. H04R 5/02; H04R 5/00

(52) U.S. Cl. 381/304; 381/1; 381/26

(57) ABSTRACT

A method and an arrangement for recording and playing back sounds, especially music, is disclosed whereby stereo recording and playback techniques are at least partially used. The arrangement allows for a three-dimensional acoustic reproduction, especially music reproduction, that comes as close to a natural experience as possible. This is achieved by as least one 2+2+2 recording and playback technique and by means of a corresponding number of sound tracks for producing a sound impression which is realistic, three dimensional, and closely resembling nature in width, depth, and height.

The invention relates to a method for recording and playing back sounds, particularly music, using at least partial stereo recording and playback techniques, and to a corresponding installation.

For audio reproduction, it is known practice to use CD players, for example, which are generally equipped at least with two-channel stereo sound reproduction using two loudspeakers. In the cinema and video sectors, the “surround” method has been used for some time to provide 3D sounds and effects. This involves placing three loudspeakers in front of the listener, namely to the left, in the center and to the right, and two further loudspeakers behind the listener. This is supplemented by a bass loudspeaker (subwoofer), which can be arranged anywhere in the room; this method is called 5+1.

The 5+1 surround method has been developed from the cinema sector and can now also be used for the private sector, although the special requirements for playing back music mean that it can be used only to a limited extent in this sector and is not satisfactory in terms of audio esthetics. The sound reproduction, similarly to quadrophony, is still two-dimensional, i.e. it is in the listening plane of the listener.

This is the starting point of the invention, whose object is to make possible three-dimensional sound reproduction which comes as close as possible to the natural experience, particularly for playing back music.

The invention achieves this object with a method of the type named in the introduction by means of at least one 2+2+2 recording and playback technique using a corresponding number of channels to produce a natural-sounding, realistic, three-dimensional audio image with left-to-right, front-to-back and up-and-down orientation.

The invention makes possible three-dimensional reproduction of natural sounds, e.g. single voices in an orchestra, soloists, singers, and the like, in highly differentiated form. In this case, during playback, the listener can feel as though he is directly at the location of the concert, more or less in the concert room; he is not forced into a single position in the room in order to perceive the best sound; he can move in areas of the room, can change his position and can still perceive the three-dimensional sound.

Refinements of the invention can be found in the subclaims.

It can be advantageous in this context to provide for a recording technique using at least six channels and a playback technique on at least six loudspeakers, with two loudspeakers from the user's horizontal listening plane being arranged with a physical offset particularly in the upward direction, as is likewise provided for by the invention. In this case, the invention is not necessarily limited to the additional pair of loudspeakers being able to be offset exclusively in the upward direction; a slight downward offset, if appropriate, can also result in similar audio images, depending on circumstances in the room.

The invention can also make provision for the two additional front loudspeakers to be arranged tilted at an angle of approximately 90° toward a wall of the room. This type of setup is particularly advantageous if the loudspeakers are in a room which is essentially rectangular from the point of view of the surface area, with the loudspeakers in the region of one of the narrower end walls, so that the additional pair of loudspeakers is oriented toward the longitudinal walls, and their sound emissions are reflected back to the listener off the wall.

If such a setup is not possible, it is also possible for the supplementary loudspeakers to be positioned at the positions of the virtual setup locations produced by the reflection. To this end, the invention provides for these two loudspeakers to be arranged with a physical offset not only particularly in the upward direction, but also at the sides of the two front loudspeakers.

In this context, the inventive procedure is additionally capable of extension; thus, the invention can provide for not only six channels to be used, but rather at least eight channels with corresponding reproduction.

An installation for carrying out the method is distinguished by a channel playback unit, a control unit with a 2+2+2 loudspeaker configuration, particularly with two main loudspeakers to the left and to the right in front of the listener, two loudspeakers to the left and to the right behind the listener and two loudspeakers above the main loudspeakers, whose axis of radiation is oriented outward through 90° with respect to said main loudspeakers. During sound recording, in addition to the technique which is needed for the known stereo reproduction, additional recordings of the 3D sound and of the corresponding perspectives are used and recordings are made on at least six audio tracks.

As already indicated above, the “DVD audio system” can be used for reproduction in this case, with the many times greater storage space allowing not just the two channels available on the CD recording to be utilized, but rather up to eight channels. In this case, the DVD system affords the opportunity to transmit a plurality of audio channels at the same time. It will be pointed out at this juncture that the “Dolby surround” method uses 5+1 channels, i.e. this also uses six channels, albeit for reproduction in one audio plane.

The inventive method and the inventive installation have the advantage that the audio images can be reproduced with left-to-right, front-to-back and up-and-down orientation, and the system can be extended. Besides conventional stereophony, four, six or more loudspeakers can be used, with the system being able to be extended to a 2+2+2+2 system, i.e. a system operating with a total of eight transmission channels.

It is noticeable that the present invention allows the “height dimension” of sound bodies, too, to be reproduced. Thus, by way of example, an orchestra sits tiered on a plurality of stages in mussel form. At the bottom are the strings, immediately behind them the woodwinds, then come the brass and the percussion, with a choir and also an organ possibly being positioned behind that.

A full organ comprises various organs placed at different points in the room; thus, by way of example, the choir organ close to the listener, the great organ above or behind that, the swell organ, the pedal organ and finally the antiphonal organs, which can resonate from the ceiling. Even with chamber music, it is possible to hear which musicians are standing and which are seated.

A listener in a concert room perceives not just the sound coming directly from the sound generator, but also the reflections off the side walls, ceilings and the like, so that the listener additionally builds up a perception about the size of the room in which he is currently situated. In this context, the invention is suitable for reproducing this realistically. A known stereo recording likewise contains these “3D sounds”, but they are driven back into just one plane and are also reproduced in this one plane. This plane is situated in just one dimension behind the loudspeaker base.

With the inventive procedure, the microphones are also positioned differently. The inventive perspective microphones are not positioned as normal supporting microphones close to or behind the instruments, but rather at a greater distance in order to allow the corresponding perspective, in which case the inventive 2+2+2 sound recording can then be produced in the mixer console from this microphone position.

In this context, the invention also makes provision for the distance between the two main loudspeakers to correspond to a base width (d) which expediently likewise corresponds to the distance from the listener, so that an isosceles triangle is produced, i.e. the two main loudspeakers are each at an angle of 30° to the optimum listening location, as is also desirable for simple stereo reproduction. The two top loudspeakers should optimally be at a height of half the width of the base above the ear level, i.e. the plane for the ears with the main loudspeakers. If the distance from the loudspeakers in the listening area is 2 m, for example, the additional front loudspeakers should be arranged at a height of 1 m above these planes. In this case, the back loudspeakers are expediently at the same distance, as much as possible, from the listener as the two front ones if this can be achieved, otherwise shorter distances can also be adopted, and the missing distance can be compensated for by oblique positioning and reflection off the wall and/or ceilings.

In this case, the additional loudspeakers should, if possible, be oriented away from the listener onto the respective wall of the room. If this is not possible, virtual locations can be ascertained at which the additional loudspeakers can then be positioned; this means offset with respect to the main loudspeakers both to the side and possibly toward the back and vertically.

Other features and details of the invention are revealed in the description below and with reference to the drawing, in which

FIG. 1 shows a simplified side view of a room for sound reproduction,

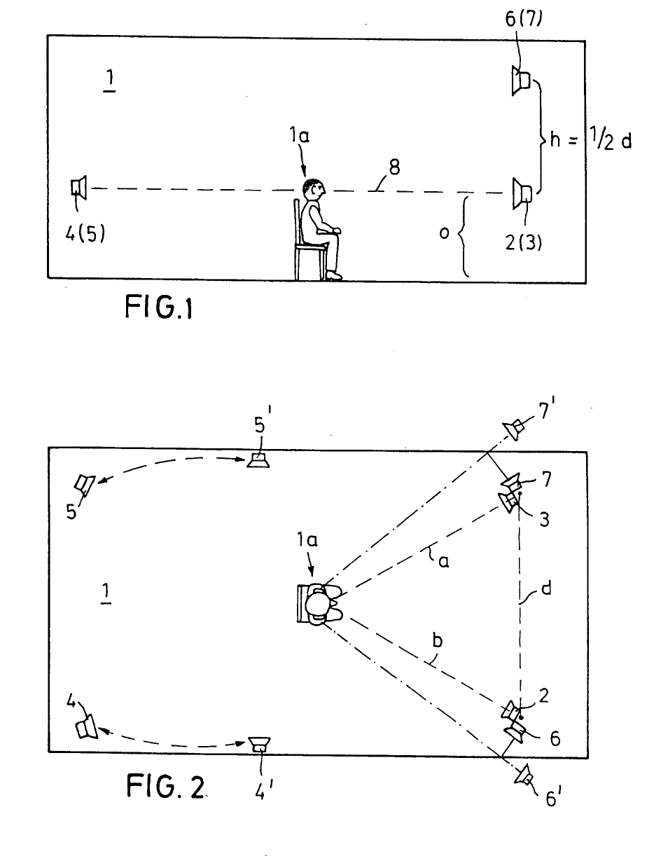

FIG. 2 shows a plan view of this room in a very highly simplified depiction,

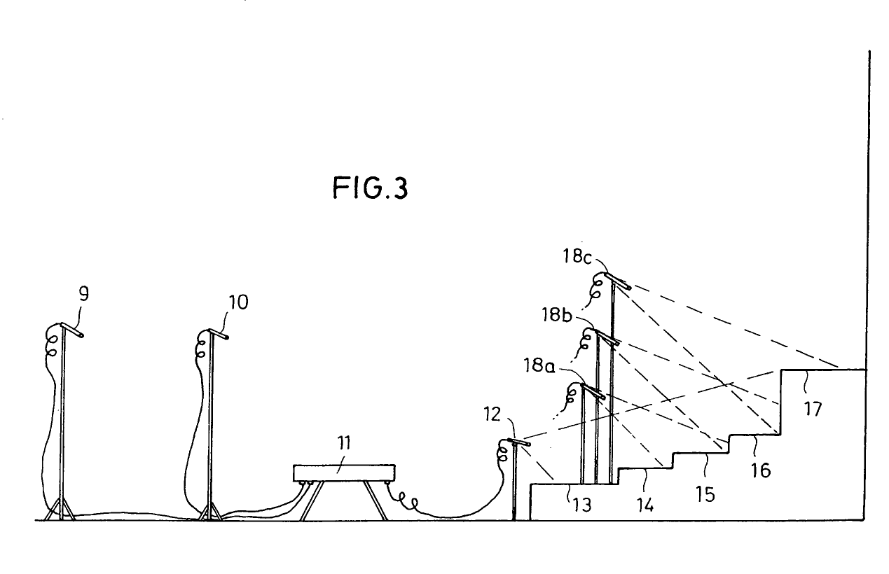

FIG. 3 shows a side view with microphone positioning for an orchestra, and

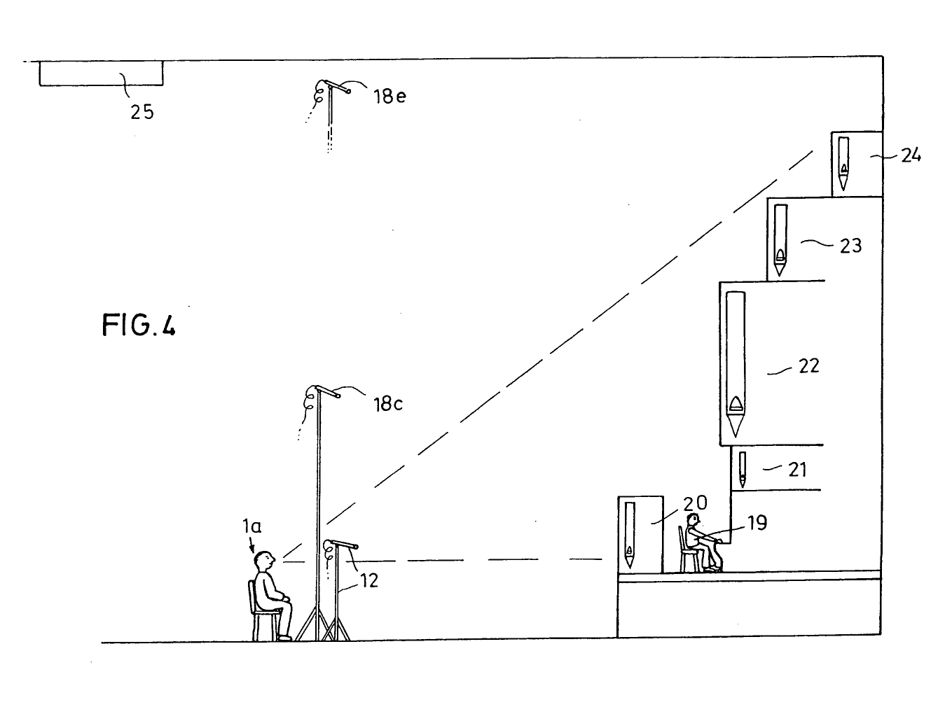

FIG. 4 shows a side view of microphone positioning for a large organ.

The room, denoted generally by 1, contains a listener 1a and, in the example depicted in FIGS. 1 and 2, six loudspeakers, namely a left-hand main loudspeaker 2 and a right-hand main loudspeaker 1, each oriented toward the listener 1a, and two back loudspeakers 4 and 5 and two additional loudspeakers 6 and 7 which are arranged above the loudspeakers 2 and 3 and are arranged outwardly directed through 90° with respect to the main loudspeakers 2 and 3, as indicated in FIG. 2.

This means that sound reproduction can be depicted not just in the listening plane 8 indicated in dashes in FIG. 1, but rather three-dimensional sound reproduction fundamentally corresponding to the natural audio image is possible.

FIG. 3 shows the possible positioning of recording microphones, with the microphones 9 and 10 representing nondirectional microphones, which can also be suspended from the ceiling of a room, for delivering the 3D sound to a mixer console, denoted generally by 11.

The main microphones, of which one is shown, are denoted by 12 and are generally situated in the front areas of a stage on which there are, by way of example, the strings in a first position 13, the woodwinds in a second position 14, the brass in a somewhat raised further position 15, with the percussion instruments at a position 16, and a choir and also possibly an organ being able to be positioned behind that at 17. In this case, “perspective microphones” are used, denoted in the figure by 18a to 18c. The information from these microphones is also supplied to the mixer console and is processed there.

FIG. 4 shows the possible positioning of recording microphones in the case of a large organ, e.g. the organ in a church or an orchestral organ in a concert room. The organ player, denoted by 19, sits at the keydesk customary for such instruments, the individual elements of the organ being indicated merely symbolically in this case:

The figure indicates a choir organ 20, a chest organ 21, a great organ 22, swell organs 23, 24 and an antiphonal organ 25. The main microphone again bears the reference 12, and the perspective microphones are denoted by 18c and 18e in this case, with these merely being setup options.

FIGS. 1 and 2 depict assigned distances. Thus, the best sitting position for stereo recordings is found to be the apex of an equilateral triangle formed by the listener 1a and the main loudspeakers 2 and 3; in FIG. 2, the limbs of this triangle are denoted by “a,b,d”, and the distance of the listening plane 8 is denoted by “o” in FIG. 1.

As FIG. 1 likewise reveals, the best distance in height between the additional front loudspeakers 6 and 7 and the main loudspeakers 2 and 3 is half the horizontal distance between the latter, i.e. h=½ d, this dimension also [lacuna] shown in FIG. 1.

Alternative positions for, by way of example, the additional top loudspeakers 6 and 7 directed onto the room wall, at positions where there are no room walls, are denoted in FIG. 2 by 6′ and 7′; alternative setup locations for the back loudspeakers 4 and 5 are denoted by 4′ and 5′.

Naturally, the described exemplary embodiments of the invention can also be modified in many respects without departing from the basic concept. Thus, the positions of the loudspeakers 2 and 3 can also be offset slightly downward, and can then possibly be tilted slightly upward to the listening location. This also applies to the additional loudspeakers 6 and 7; these can also be offset slightly forward or backward from their freed vertical plane in order possibly to be able to take into account intentional peculiarities of the setup location.

1. A method for recording and playing back sounds, particularly music, using at least partial stereo recording and playback techniques,
characterized by
at least one 2+2+2 recording and playback technique using a corresponding number of channels to produce a natural-sounding, realistic, three-dimensional audio image with left-to-right, front-to-back and up-and-down orientation.

2. The method as claimed in claim 1,
characterized by
a recording technique using at least six channels and by a playback technique on at least six loudspeakers, with two loudspeakers from the user's horizontal listening plane being arranged with a physical offset particularly in the upward direction.

3. The method as claimed in claim 1 or 2,
characterized
in that the two additional front loudspeakers are arranged tilted at an angle of approximately 90° toward a wall of the room.

4. The method as claimed in one of the preceding claims,
characterized
in that two loudspeakers are arranged with a physical offset not only particularly in the upward direction, but also at the sides of the two front loudspeakers.

5. The method as claimed in one of the preceding claims,
characterized in that the playback is on the DVD audio system (Digital Versatile Disk).

6. The method as claimed in one of the preceding claims,
characterized
in that recording and playback are effected using at least eight channels of the highest audio quality.

7. An installation, particularly for carrying out the method as claimed in one of the preceding claims,
characterized by
a channel playback unit, a control unit with a 2+2+2 loudspeaker configuration, particularly with two main loudspeakers (2,3) to the left and to the right in front of the listener, two loudspeakers (4,5) to the left and to the right behind the listener and two loudspeakers (6,7) above the main loudspeakers.

8. The installation, particularly for use in the private sector, as claimed in claim 7,
characterized
in that, assuming a standard listening position, the two front supplementary loudspeakers (6,7) arranged above the main loudspeakers are positioned in an equilateral triangle between the listening location and the two main loudspeakers (3) at a height (h) of half the width of the base above ear level (o).

9. The installation as claimed in claim 8,
characterized
in that the supplementary loudspeakers (6,7) offset by height (h) in the upward direction are equipped outward through 90° for the purpose of reflection off the wall of the room.

10. The installation as claimed in claim 7 or in one of the succeeding claims,
characterized
in that the supplementary loudspeakers (6 or 7) are positioned at the sides of the virtual locations (6′,7′), oriented toward the listening location in the absence of reflecting room walls.

11. The installation as claimed in one of the preceding claims for recording a sound,
characterized by
a recording mixer console (11) with nondirectional microphones (9,10) positioned in the recording room above, in front of and behind the imaginary listener, main microphones positioned in front of the sound generators, and perspective microphones (18) arranged above in the region of the sound body.
